(19) United States
(12) Patent Application Publication
(10) Pub. No.: US 2011/0115193 A1
(43) Pub. Date: May 19, 2011

(54) BICYCLE FRAME AND BOTTOM BRACKET SHELL ASSEMBLY FOR INTERNALLY ROUTED CABLES

(76) Inventor: Michel Giroux, Jonquiere (CA)

(21) Appl. No.: 12/995,643

(22) PCT Filed: Jun. 4, 2009
(86) PCT No.: PCT/CA2009/000782

§ 371 Date: Jan. 24, 2011

Related U.S. Application Data
(60) Provisional application No. 61/059,387, filed on Jun. 6, 2008.

(51) Int. Cl. B62K 19/34; B62K 19/36; B62H 5/00

(52) U.S. Cl. 280/281.1

(57) ABSTRACT

There is provided a bottom bracket shell assembly for a hollow frame of a pedal-driven vehicle. The assembly comprises a bottom bracket shell comprising a first side open end, a second, opposed side open end and a shell wall extending therebetween, the shell wall defining a cylindrical cavity adapted for receiving a bottom bracket therein, and a casing mounted to the shell wall of the bottom bracket shell and extending upwardly therefrom, the casing comprising at least one wall defining a chamber and a closable access opening for accessing the chamber, the at least one wall comprising at least one communication opening adapted to allow communication between the interior of the hollow frame and the chamber.

### CROSS REFERENCE TO RELATED APPLICATIONS

This application claims the benefits of U.S. provisional patent application No. 61/059,387 filed on Jun. 6, 2008, the specification of which is hereby incorporated by reference.

This application is related to U.S. provisional patent application No. 61/059,421 entitled SADDLE ANTI-THEFT DEVICE, filed on Jun. 6, 2008, the specification of which is hereby incorporated by reference.

This application is related to U.S. provisional patent application No. 61/059,404 entitled HANDLEBAR FOR A BICYCLE, filed on Jun. 6, 2008, the specification of which is hereby incorporated by reference.

This application is related to U.S. provisional patent application No. 61/059,413 entitled FORK ASSEMBLY FOR A BICYCLE, filed on Jun. 6, 2008, the specification of which is hereby incorporated by reference.

### FIELD OF THE INVENTION

The invention relates to a bicycle frame. More precisely, the invention pertains to a bottom bracket shell assembly and a hollow bicycle frame comprising the same.

### BACKGROUND OF THE INVENTION

Bicycles have been utilized as means of transportation for over a hundred of years. Modern bicycles generally include control cables which are used to control front and rear wheel braking systems, and front and rear shifting mechanism. Typically, the cables are routed from brake and shift levers to the braking systems and derailleur. The bicycle may also have wires for an odometer and front and rear lights. Those cables and wires are generally mounted along the outside of the bicycle frame with various attachments such as clips.

Cables and wires can interfere with either the rider or other components of the bicycles (e.g. tool compartment attached to the frame). Externally located cables and wires are susceptible to damage from the surrounding environment (e.g. three, branches) and also to vandalism. The cables may also detract from the aesthetic appearance of the frame by covering art or graphic logos.

For different reasons, many cities have inaugurated in the recent years bicycle sharing programs whereby citizens can easily have access to bicycles for inner-city transportation. Although very popular, those programs have to struggle against theft and vandalism. There is therefore an urgent need for new bicycles with a singular design of frame for preventing vandalism or disassembly of the parts or the bicycles.

Prior attempts have been made to conceal bicycle cables and wires by extending the cables through the inside of the bicycle frame components. Examples can be found in U.S. Pat. No. 7,114,738 and U.S. Patent Publications Nos. US 2004/0188976 and 2006/0145446. However, those frames do not address all of the above-identified problems, either because they maintain some exposed segments of cables, because they are too complex, because the configuration of the frame is such that cables wear prematurely due to continuous scrubbing against the frame, or because they are not adaptable to bicycles designed to be utilized in bicycle sharing programs.

Therefore, it would be desirable to be provided with a bicycle frame wherein cables and/or wires for brakes, gear shifting, lightning and the like are concealed inside the bicycle frame. It would also be desirable to be provided with a bicycle frame comprising a casing for accessing hidden cables and/or wires passing inside the bicycle frame.

Features of the invention will be apparent from review of the disclosure, drawings and description of the invention below.

### BRIEF SUMMARY

In accordance with an embodiment, there is provided a bottom bracket shell assembly for use with a hollow frame of a pedal powered vehicle.

In accordance with an embodiment, the assembly comprises a bottom bracket shell comprising a first side open end, a second, opposed side open end and a shell wall extending therebetween, where the shell wall defines a cylindrical cavity adapted for receiving a bottom bracket therein; a casing mounted to the shell wall of the bottom bracket shell and extending upwardly therefrom, the casing comprising at least one wall defining a chamber and a closable access opening for accessing the chamber, the at least one wall comprising at least one communication opening adapted to allow communication between the interior of the hollow frame and the chamber.

According to an embodiment, the casing comprises a back wall having a bottom end connected to the shell wall and a top end, a spaced-apart front wall having a bottom end connected to the shell wall and a top end, and a top wall connecting the top end of the back wall to the top end of the front wall.

According to another embodiment, the back, front and top walls define together a first side edge and a second side edge.

According to yet another embodiment, the first side edge defines a rim surrounding the access opening, the rim being configured to enable securing a cover to the first side edge for preventing access to the chamber.

According to a further embodiment, the rim comprises at least one threaded hole defined therein, the at least one threaded hole being configured for removably securing at least one corresponding cover fastener therein, wherein when the at least one cover fastener is secured in the at least on threaded hole, the cover is maintained in abutment against the rim thereby preventing access to the chamber.

According to an embodiment, the at least one cover fastener is adapted to be removed using a dedicated tool.

In accordance with an embodiment, the at least one communication opening comprises a hole extending through one of the back wall, the front wall and the top wall.

In accordance with another embodiment, the at least one communication opening comprises an indentation defined in the second side edge.

In accordance an embodiment, the indentation is defined in the front wall.

In accordance with a further embodiment, the at least one communication opening is surrounded by the second side edge of the casing.

According to an embodiment, the casing is configured for enabling a portion of a seat tube of the frame to simultaneously contact the casing and the shell wall.

In accordance with an embodiment, the casing extends between the first end of the shell wall to an intermediate region located between the first and second ends thereof to allow positioning of a portion of the seat tube adjacent to the casing.

According to another embodiment, the casing comprises three communication openings.

According to an embodiment, a first communication opening is defined in the front wall, a second communication opening is defined in the back wall and a third opening is surrounded by the second side edge.

According to a further embodiment, the top wall comprises a saddle anti-theft mounting portion.

According to yet a further embodiment, the saddle anti-theft mounting portion comprises a protrusion extending sidewardly from the second side edge and a hole extending through the protrusion, the hole being configured for abuttingly receiving therein a rod.

According to another embodiment, the hole extends in a recess defined on the top wall, the recess being sized and shaped to receive therein a corresponding portion of the rod when the rod is received in the hole.

According to yet another embodiment, the assembly further comprises a fastener for securely fastening the rod to the top wall once the rod has been engaged in the hole.

In accordance with an embodiment, the assembly further comprises a cover fixedly mounted to the second side edge to prevent access to the chamber.

In accordance with another embodiment, the casing comprises three communication openings.

According to an embodiment, a first communication opening is defined in the front wall and second and third communication openings are defined in the back wall.

According to an embodiment, the pedal powered vehicle comprises a pedal powered vehicle for a sharing system.

According to another embodiment, the pedal powered vehicle is selected from a group consisting of a bicycle and a tricycle.

In accordance with a further embodiment, there is provided a hollow frame for a pedal powered vehicle.

In accordance with an embodiment, the hollow frame comprises a hollow down tube having a first, upper end for connecting a fork assembly to the frame and a second, lower end; a hollow seat tube having a first, upper open end for mounting a saddle assembly to the seat tube and a second lower end; at least one hollow chain stay having a first, rear end for mounting a rear wheel to the frame and a second, front end; a bottom bracket shell assembly connected to the lower end of the seat tube, the lower end of down tube and the front end of the at least one chain stay, the bottom bracket shell assembly comprising a bottom bracket shell comprising a first side open end, a second, opposed side open end and a shell wall extending therebetween, the shell wall defining a cylindrical cavity adapted for receiving a bottom bracket therein; and a casing mounted to the shell wall of the bottom bracket shell and extending upwardly therefrom, the casing comprising at least one wall defining a chamber and a closable access opening for accessing the chamber, the at least one, wall comprising at least one communication opening adapted to allow communication between the chamber and the interior of at least one of the down tube, the seat tube and the chain stay.

In accordance with an embodiment, the casing comprises a front wall adjacent to the second, lower end of the down tube, the front wall having a bottom end connected to the shell wall and a top end; a spaced-apart back wall adjacent to the second, front end of the chain stay, the back wall having a bottom end connected to the shell wall and a top end; and a top wall connecting the top end of the back wall to the top end of the front wall.

According to an embodiment, the back, front and top walls define together a first side edge and a second side edge.

According to another embodiment, the first side edge defines a rim surrounding the access opening, the rim being configured to enable securing a cover to the first side edge for preventing access to the chamber.

According to a further embodiment, the rim comprises at least one threaded hole defined therein, the at least one threaded hole being configured for removably securing at least one corresponding cover fastener therein, wherein when the at least one cover fastener is secured in the at least on threaded hole, the cover is maintained in abutment against the rim thereby preventing access to the chamber.

According to yet a further embodiment, the at least one cover fastener is adapted to be removed using a dedicated tool.

According to another embodiment, the at least one communication opening comprises a hole extending through one of the back wall, the front wall and the top wall.

According to yet another embodiment, the at least one communication opening comprises an indentation defined in the second side edge.

According to a further embodiment, an indentation is defined in the front wall.

According to an embodiment, the at least one communication opening is surrounded by the second side edge of the casing.

According to an embodiment, the casing of the bottom bracket shell assembly and the seat tube are configured for enabling a portion of the seat tube to simultaneously contact the casing and the shell wall of the bottom bracket shell assembly.

According to an embodiment, the casing of the bottom bracket shell assembly extends between the first end of the shell wall to an intermediate region located between the first and second ends thereof thereby defining a seat tube receiving space between the intermediate region and the second end of the shell wall; and the seat tube comprises a mounting portion extending at the second, lower end thereof, the seat tube mounting portion being sized and shape for being received in the seat tube receiving space and simultaneously mating connection with shell wall and the casing of the bracket shell assembly.

According to a further embodiment, the casing comprises three communication openings.

According to yet a further embodiment, a first communication opening is defined in the front wall, the first communication opening allowing communication between the chamber of the casing and the interior of the down tube.

According to another embodiment, a second communication opening is defined in the back wall, the second communication opening allowing communication between the chamber of the casing and the at least one chain stay.

According to yet another embodiment, a third communication opening is defined by the second side edge, the third opening allowing communication between the chamber and the interior of the seat tube.

According to an embodiment, the frame comprises two chain stays and the seat tube comprises a lower opening, the back wall of the casing being adjacent to a first chain stay and the seat tube mounting portion being adjacent to a second chain stay, the second communication opening allowing communication between the chamber of the casing and the first chain stay and the lower opening allowing communication between the interior of the seat tube and the second chain stay.

According to a further embodiment, the top wall comprises a saddle anti-theft mounting portion.

According to yet a further embodiment, the saddle anti-theft mounting portion comprises a protrusion extending sidewardly from the second side edge and a hole extending through the protrusion, the hole being configured for abuttingly receiving therein a rod.

According to another embodiment, the hole extends in a recess defined on the top wall, the recess being sized and shaped to receive therein a corresponding portion of the rod when the rod is received in the hole.

According to yet another embodiment, the frame further comprises a fastener for securely fastening the rod to the top wall once the rod has been engaged in the hole.

According to an embodiment, the frame further comprises a cover fixedly mounted to the second side edge to prevent access to the chamber.

According to another embodiment, the casing comprises three communication openings.

According to yet another embodiment, a first communication opening is defined is defined in the front wall, the first communication opening allowing communication between the chamber of the casing and the interior of the down tube.

According to an embodiment, a second communication opening is defined in the back wall, the second communication opening allowing communication between the chamber of the casing and a first chain stay.

According to another embodiment, a third communication opening is defined in the back wall, the third communication opening allowing communication between the chamber of the casing and a second chain stay.

These and other objects, advantages and features of the present invention will become more apparent to those skilled in the art upon reading the details of the invention more fully set forth below.

### BRIEF DESCRIPTION OF THE DRAWINGS

In order that the invention may be readily understood, embodiments of the invention are illustrated by way of example in the accompanying drawings.

FIG. 1 is a drawing showing a perspective view of a bicycle having a bottom bracket shell assembly mounted thereto, in accordance with one embodiment.

FIG. 2 is a drawing showing a perspective view of a hollow frame of the bicycle shown in FIG. 1.

FIG. 3A is a drawing showing a perspective view of a seat tube of the hollow frame shown in FIG. 2.

FIG. 3B is a drawing showing an enlarged perspective view of the seat tube shown in FIG. 3A.

FIG. 4 is a drawing showing a perspective view of a bottom bracket shell assembly for the bicycle shown in FIG. 1.

FIG. 5 is a drawing showing another perspective view of the bottom bracket shell assembly shown in FIG. 4.

FIG. 6 is a drawing showing a front elevation view of the bottom bracket shell assembly shown in FIG. 4.

FIG. 7 is drawing showing a back elevation view of the bottom bracket shell assembly shown in FIG. 4.

FIG. 8 is drawing showing a left elevation view of the bottom bracket shell assembly shown in FIG. 4.

FIG. 9 is drawing showing a right elevation view of the bottom bracket shell assembly shown in FIG. 4.

FIG. 10A is drawing showing a top elevation view of the bottom bracket shell assembly shown in FIG. 4.

FIG. 10B is drawing showing a bottom elevation view of the bottom bracket shell assembly shown in FIG. 4.

FIG. 11A is drawing showing a perspective view of the seat tube shown in FIG. 3A mounted to the bottom bracket shell assembly shown in FIG. 4.

FIG. 11B is drawing showing a front elevation view of the seat tube mounted to the bottom bracket shell assembly as shown in FIG. 11A.

FIG. 12A is a drawing showing a seat tube, in accordance with an alternative embodiment, mounted to a bottom bracket shell assembly, also in accordance with an alternative embodiment.

FIG. 12B is a drawing showing a front elevation view of the seat tube mounted to the bottom bracket shell assembly as shown in FIG. 12A.

FIG. 12C is a drawing showing a back elevation view of the seat tube mounted to the bottom bracket shell assembly as shown in FIG. 12A.

FIG. 13A is a drawing showing an exploded perspective view of a hollow bicycle frame and a seat assembly having a seat-anti theft assembly coupled thereto, in accordance with one embodiment, to better show the components of the seat anti-theft assembly.

FIG. 13B is a drawing showing an enlarged cross-section view, taken along line XIII-XIII of FIG. 2, of the bottom bracket shell assembly shown in FIG. 13A having a seat anti-theft assembly mounted thereto, to better show the mounting of the seat anti-theft assembly to the bottom bracket shell assembly.

FIG. 14 is a drawing showing an exploded perspective view of part of a drive assembly of a bicycle, in accordance with one embodiment.

FIG. 15 is a drawing showing a partial cross-section view of a hollow frame for a bicycle, in accordance with one embodiment, with cables passing therethrough.

FIG. 16 is a drawing showing an enlarged cross-section view, taken along line XIII-XIII of FIG. 2, of the hollow frame shown in FIG. 15, with a cable passing therethrough.

FIG. 17 is a drawing showing a perspective view of a bottom bracket shell assembly, in accordance with an alternative embodiment.

Further details of the invention and its advantages will be apparent from the detailed description included below.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

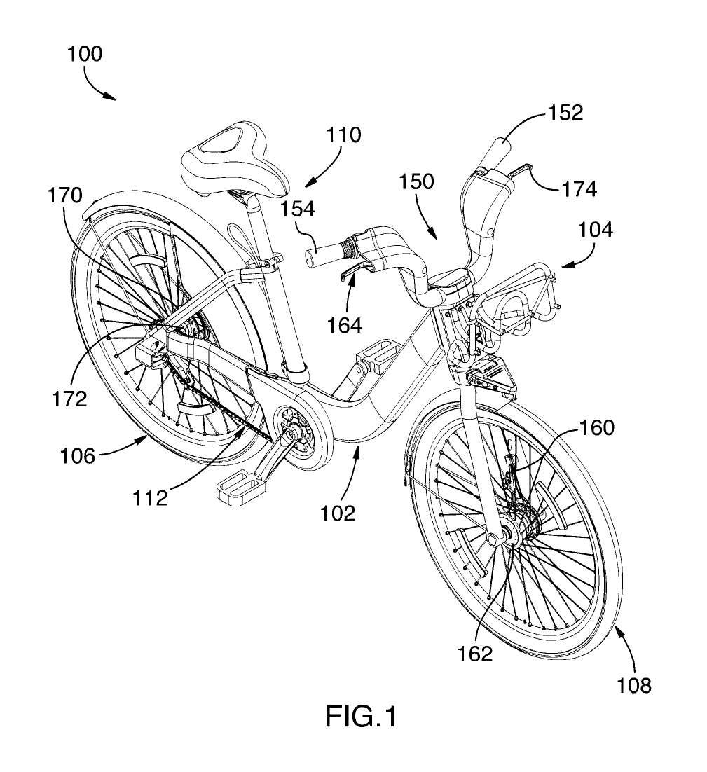

With reference to FIG. 1, there is shown a bicycle 100 in accordance with one embodiment. The bicycle 100 comprises a hollow frame 102, a fork assembly 104 mounted to the frame 102 and back and front wheel 106, 108, respectively. The bicycle 100 further comprises a seat assembly 110 for enabling a user to sit on the bicycle 100 and a drive assembly 112 for pedaling.

While the present description refers to a “bicycle”, the skilled addressee will appreciate that the present invention is not limited to a two-wheeled vehicle and that any other pedal powered vehicle comprising a frame, for instance a tricycle, may be substituted to the bicycle. Further, the skilled addressee will appreciate that the term “pedal powered vehicle” is not limited to vehicles powered exclusively by pedaling but that it also comprises vehicles provided with both pedals and motors such as Velosolex™ and mopeds.

In one embodiment, the pedal powered vehicle comprises a pedal powered vehicle used in a sharing program. A sharing program usually uses a large quantity of pedal powered vehicles.

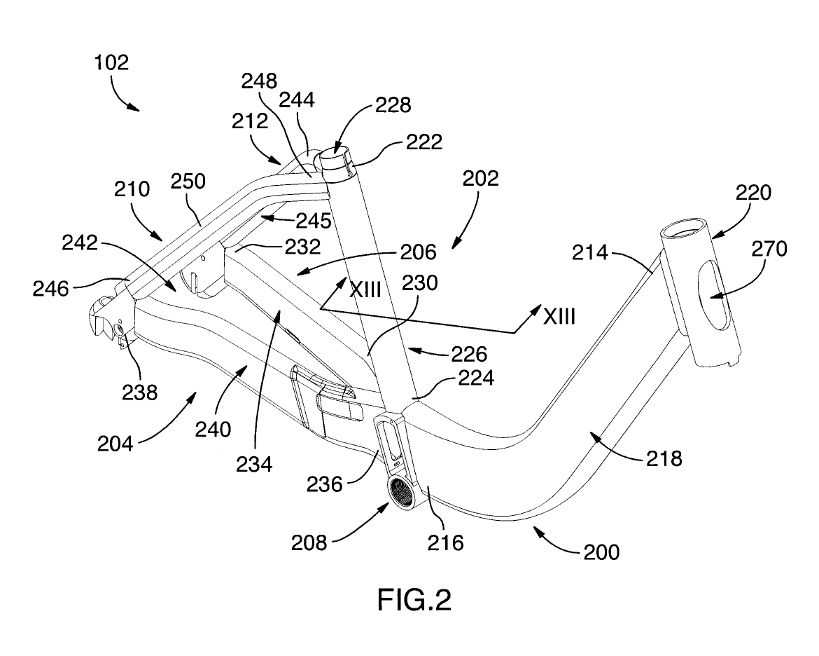

According to the embodiment shown in FIG. 2, the hollow frame 102 is configured for internally routing cables or wires therein. Such a hollow frame 102 advantageously contributes to preventing premature wear of the cables or wires caused by a scrubbing of the cables or wires against the frame 102. Protecting the cables and wires passing through the frame further prevents the cables from being exposed to natural elements such as rain and dust, which in turn contributes to preventing the cables and wires from being damaged. Cables or wires routed in the hollow frame are further protected from vandalism. This is of great advantage, especially if the bicycle is used in a bicycle sharing program in which bicycles are usually stored in public areas.

The hollow frame 102 comprises a hollow down tube 200, a hollow seat tube 202 and a pair of hollow left and right chain stays 204, 206. The down tube 200, the seat tube 202 and the chain stays 204, 206 are connected to each other by a hollow bottom bracket shell assembly 208, which will be described in greater detail below. The hollow frame 102 further comprises a pair of left and right seat stays 210, 212 connecting the seat tube 202 to the chain stays 204, 206.

The down tube 200 comprises an upper, front end 214 to which is mounted a head tube 220 and a lower, back end 216 connected to the bottom bracket shell assembly 208. Extending between the upper end 214 and the lower end 216 is a wall 218 defining a down tube cavity, not shown. Taking the bottom bracket shell assembly 208 as reference, the down tube 200 extends frontwardly and curves upwardly such that the front, upper end 214 is positioned higher than the back, lower end 216.

The skilled addressee will appreciate that the weight of a user riding the bicycle 100 may tend to exert bending strain on the down tube 200 and that the down tube 200 must be configured to sustain such bending. Therefore, in accordance with one embodiment, the wall 218 of the down tube 200 has a generally oval or oblong cross-section defining a box beam profile. This configuration advantageously confers great resistance against bending to the down tube 200 and provides additional space for routing cables inside the down tube 200, as it will become apparent below. While in the embodiment shown in FIG. 2 the wall 218 of the down tube 200 has a generally oval or oblong cross-section, any hollow down tube configuration could be used. For instance, the down tube 200 may have a generally circular, square or rectangular cross-section.

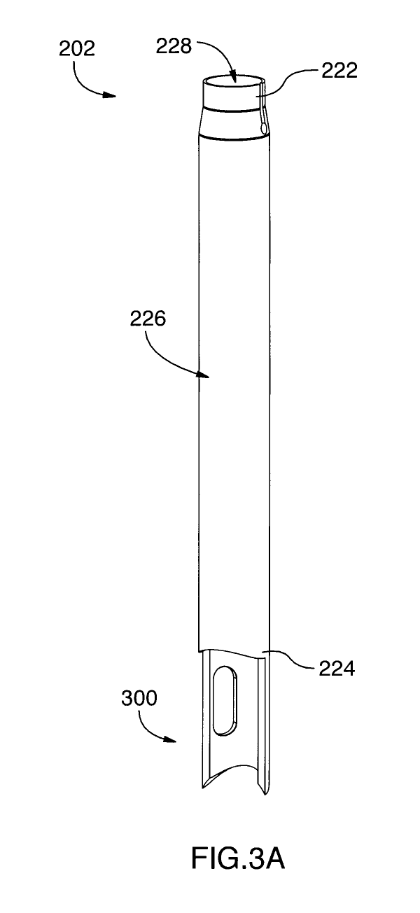

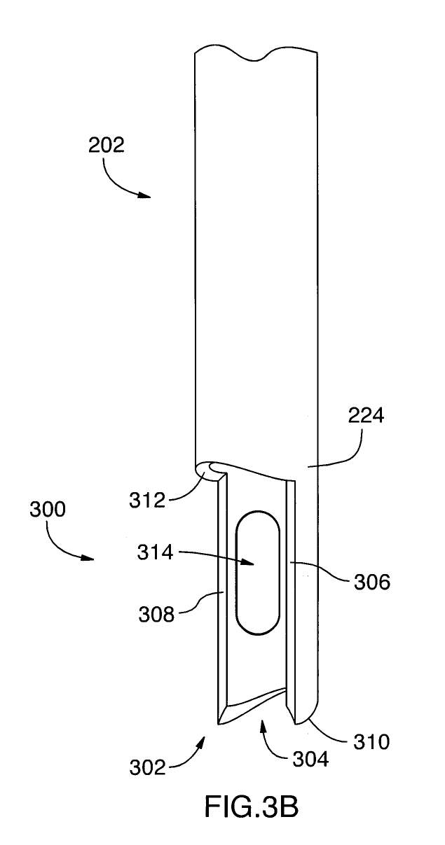

Still taking the bottom bracket shell assembly 208 as reference, the seat tube 202 is shown to extend upwardly and slightly rearwardly, as best shown in FIG. 1. With references to FIGS. 2, 3A and 3B, the seat tube 202 comprises a top open end 222, an opposed bottom end 224 connected to the bottom bracket shell assembly 208 and a seat tube wall 226 extending therebetween and defining an internal seat tube cavity 228. The top open end 222 of the seat tube 202 is adapted for receiving the seat assembly 110, as it will be further described below.

According to one embodiment, a mounting portion 300 is defined at the bottom end 224 of the seat tube 202. The mounting portion 300 comprises a cutaway section 302 defining a complementary semi-cylindrical wall 304. The semi-cylindrical wall 304 comprises a pair of first and second generally straight, parallel side edges 306, 308 and a lower curved edge 310 defining a bottom end of the semi-cylindrical wall 304. The cutaway section 302 further defines an upper curved edge 312 connecting the first and second parallel edges 306, 308, the upper curved edge 312 being curved away from the semi-cylindrical wall 304. Defined in the semi-cylindrical wall 304, proximal to the second side edge 308 thereof, is a lower opening 314 sized and shaped for allowing passage of at least one cable therethrough. The mounting portion 300 is adapted for engaging the bottom bracket shell assembly 208, as it will become apparent below.

Now referring back to FIG. 2, the left chain stay 206 comprises a front end 230 connected to the bottom bracket shell assembly 208, an opposed rear end 232 and a wall 234 extending therebetween. In the present embodiment, the wall 234 defines a left chain stay cavity, not shown. Similarly, the right chain stay 204 comprises a front end 236 connected to the bottom bracket shell assembly 208, an opposed rear end 238 and a wall 240 extending therebetween and defining a right chain stay cavity, not shown.

While in this embodiment, both the left chain stay 204 and the right chain stay 206 are provided with a chain stay cavity, the skilled addressee will appreciate that the number of chain stay cavities defined in the hollow frame 102 is determined by the number and nature of cables routed through the hollow frame 102 and that, for instance, only one of the left chain stay 204 and the right chain stay 206 could be provided with a cavity.

Still taking the bottom bracket shell assembly as point of reference, the left and right chain stays 204,206 extend rearwardly from the bottom bracket shell assembly 208 and diverge from one another from the front ends 230, 236 to the rear ends 232, 238, such that a space 242 sufficient for receiving a hub of the back wheel 106 is created between the rear end 232 of the left chain stay 204 and the rear end 238 of the right chain stay 206. As shown in FIG. 1, the rear wheel 106 is engaged in the space 242 and is rotatably mounted to the back end 232 of the left chain stay 206 and the back end 238 the right chain stay 204.

For providing additional strength to the frame 102, the left and right chain stays 204, 206 are connected to the seat tube 202 by the left and right seat stays 212, 210. It will be appreciated by the skilled addressee that, the seat tube 202 being slightly rearwardly inclined as mentioned hereabove, the left and right seat stays 212, 210 are arranged in a support beam configuration for supporting the seat tube 202 when a user is riding the bicycle 100.

Accordingly, the left seat stay 212 comprises a lower end, not shown, connected to the left chain stay 206, proximal to the rear end 232 thereof, a second upper end 244 connected to the seat tube 202, proximal to the top end 222 thereof, and a wall 245 extending between the lower end, not shown, and the upper end 244. Similarly, the right seat stay 210 comprises a lower end 246 connected to the right chain stay 204, proximal to the rear end 238 thereof, a second upper end 248 connected to the seat tube 202, proximal to the top end 222 thereof, and a wall 250 extending between the lower end 246 and the upper end 248. It will thus be appreciated that the left and right seat stays 212, 210 extend upwardly and frontwardly from the rear ends 232, 238 of the chain stays 204, 206 to the top open end 222 of the seat tube 202.

While in the above described embodiment, the frame 102 may comprise a down tube 102, a seat tube 202, a left and right chain stay 206,204, a left and right seat stay 212,210 and a bottom bracket shell assembly 208, it will be appreciated that the frame 102 may be configured differently. For instance, in an alternative embodiment, the bicycle frame 102 further comprises a top tube extending between the top open ends 222, 214 of the seat tube 202 and the down tube 200. This configuration would provide the bicycle frame 102 with even greater robustness.

In one embodiment, all of the components of the frame 102 are made of a rigid metal material such as for instance an alloy made of at least one of aluminum, magnesium, titanium or the like, which confers great robustness to the bicycle 100.

In an alternative embodiment, the components of the frame 102 may be made of a lighter yet resistant material such as carbon fiber, fiberglass or a thermoplastic such as polyvinyl chloride, polypropylene, acrylonitrile butadiene styrene or polycarbonate, all of which contribute to reducing the overall weight of the bicycle 100 without compromising its strength.

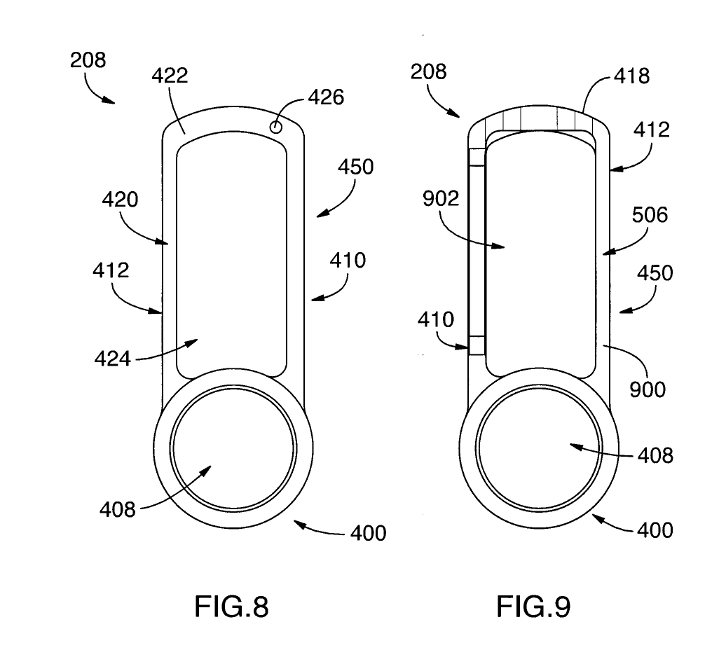

Having described the general configuration of the frame 102, the bottom bracket shell assembly 208 will now be described, with reference to FIGS. 2 to 10B.

For connecting the lower end 216 of the down tube 200, the lower end 224 of the seat tube 202, the front end 230 of the left chain stay 206 and the front end 236 of the right chain stay 204, the bottom bracket shell assembly 208 is provided. The bottom bracket shell assembly 208 is adapted for mounting the drive assembly 112 to the frame 102 while allowing cables to be routed through the hollow frame 102. Accordingly, the bottom bracket shell assembly 208 comprises a bottom bracket shell 400 adapted to receive a bottom bracket, not shown, of the drive assembly 112 and further comprises a casing 450 mounted to the bottom bracket shell 400.

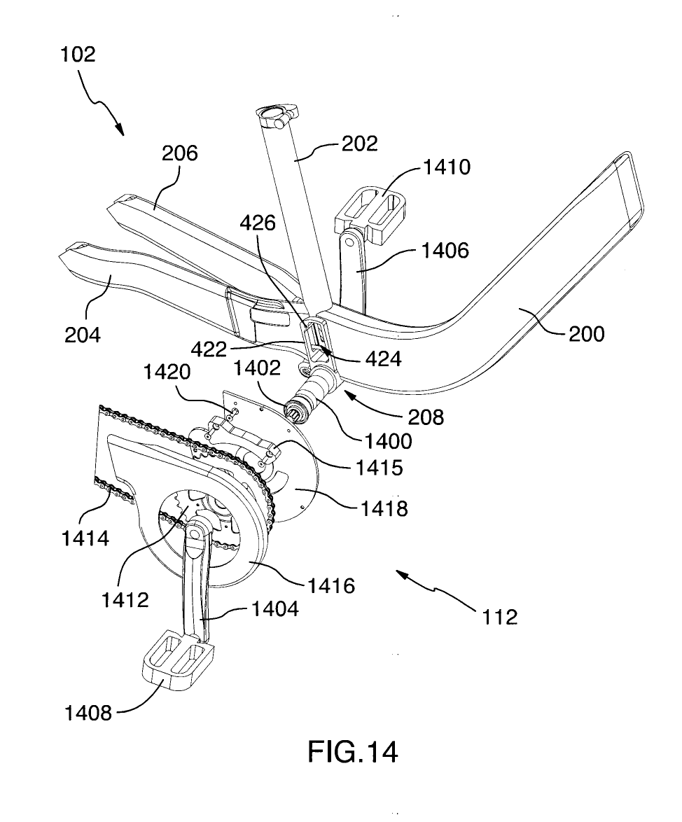

The bottom bracket shell 400 comprises a first side open end 402, a second, opposed side open end 404 and a shell wall 406 extending therebetween, the shell wall 406 defining a cylindrical cavity 408 in which is inserted and secured the corresponding cylindrical bottom bracket 1400, as best shown in FIG. 14. In the illustrated embodiment, the shell wall 406 comprises an internal threaded surface 410 adapted for threadily engaging a corresponding external threaded surface of the bottom bracket, not shown, for securing the bottom bracket 1400 to the bottom bracket shell 400.

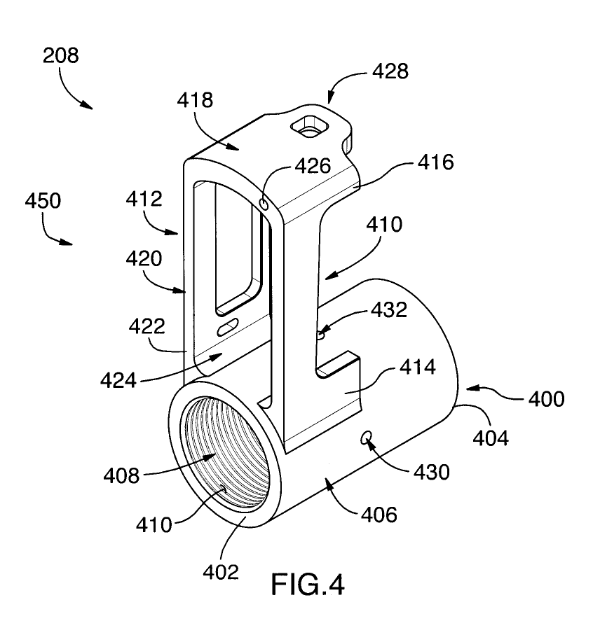

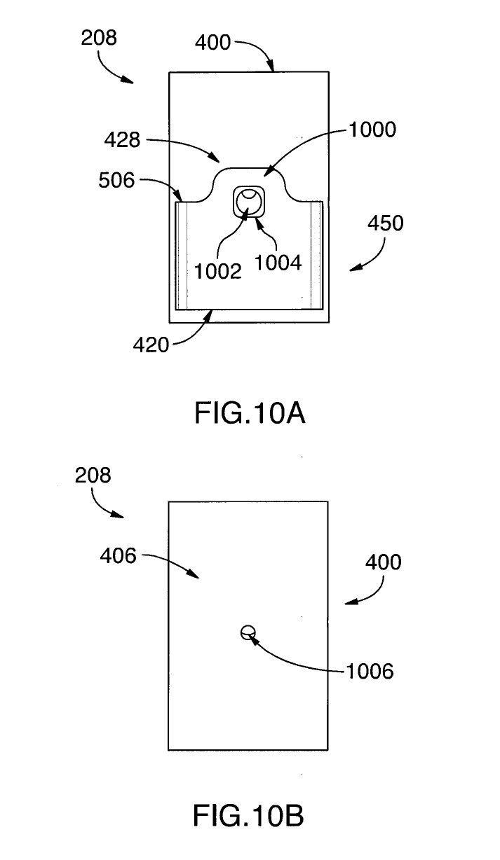

It will be appreciated that an accumulation of water such as rain water in the hollow frame 102 may damage the cables and wires routed through the frame 102. As shown in FIG. 4, in one embodiment, the shell wall 406 of the bottom bracket shell 400 has a first drain opening 430 and a second drain opening 432 defined therein. The first drain opening 430 is adapted to allow fluid communication between the down tube 200 and the cylindrical cavity 408 of the bottom bracket shell 400, while the second drain opening 432 is adapted to allow fluid communication between the casing 450 and the cylindrical cavity 408 of the bottom bracket shell 400. A discharge opening 1006 is further defined on the shell wall 406, as best shown in FIG. 10B and is positioned such that it allows fluid to be evacuated from the cylindrical cavity 408. Water infiltrated in the down tube 200 may therefore be drained through the first drain opening 430 into the cylindrical cavity 408 and evacuated through the discharge opening 1006, while water infiltrated in the casing 450 may be drained through the second drain 432 opening into the cylindrical cavity 408 and evacuated through the discharge opening 1006.

Mounted to the shell wall 406 of the bottom bracket shell 400 is the casing 450. The casing 450 has a generally rectangular shape and extends generally radially from the bottom bracket shell 400. The casing 450 comprises a pair of spaced-apart front and back walls 410, 412 extending outwardly from the shell wall 406, and a top convex wall 418.

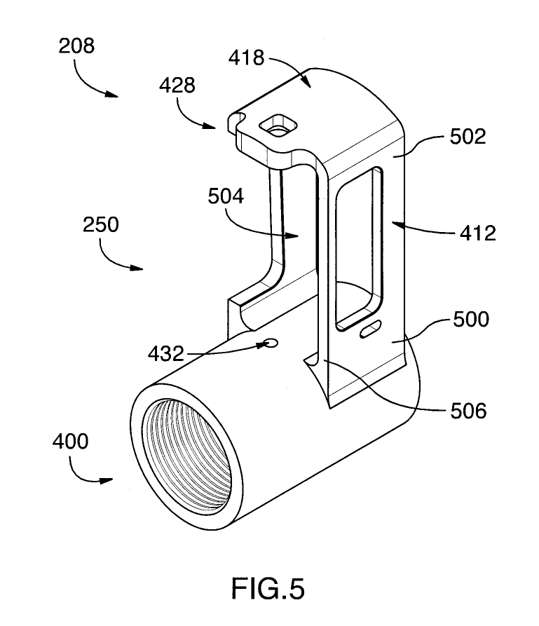

The front wall 410 comprises a bottom end 414 mounted to the bottom bracket shell 400 and an opposed top end 416. The back wall 412 extends parallel to the front wall 410 and also comprises a bottom end 500 mounted to the bottom bracket shell 400 and an opposed top end 502, best shown in FIG. 5. Connecting the top end 502 of the back wall 412 and the top end 416 of the front wall 410 is the convex top wall 418, bulging away from the bottom bracket shell 400. When the hollow frame 102 is properly assembled, as best shown in FIG. 2, the top wall 418 is adjacent to the seat tube 208 and connected thereto, while the front wall 410 is adjacent to the down tube 200 and connected thereto and the back wall 412 is adjacent to the right chain stay 204 and connected thereto.

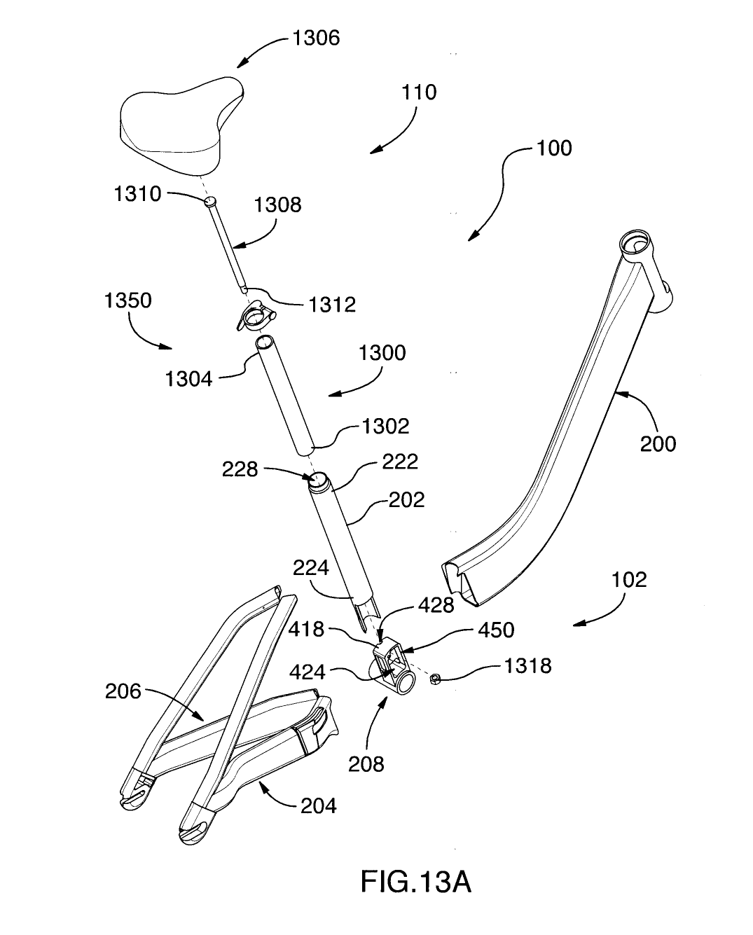

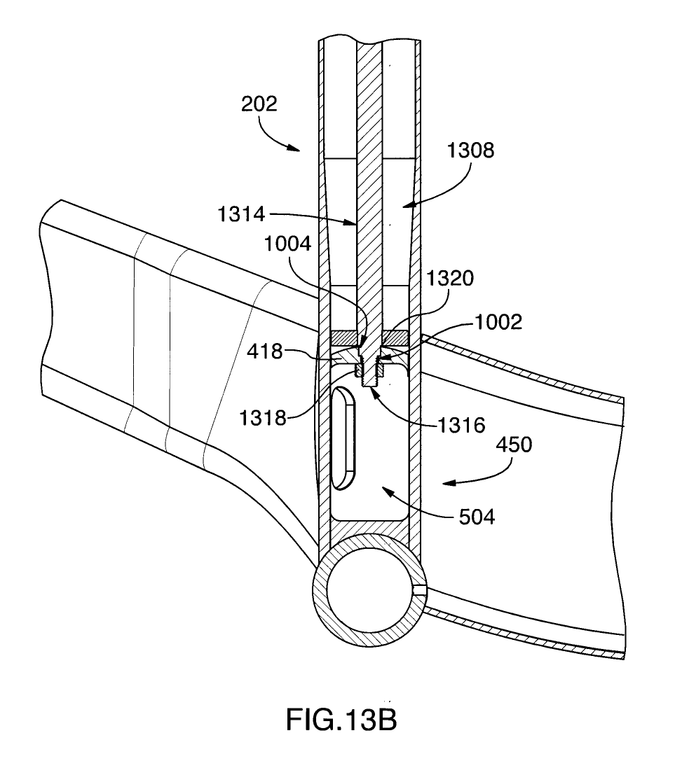

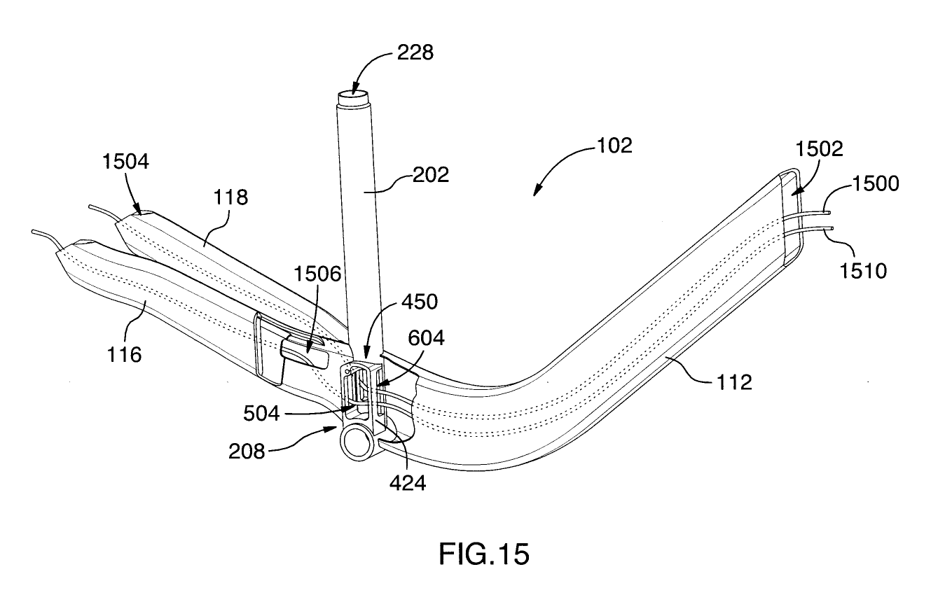

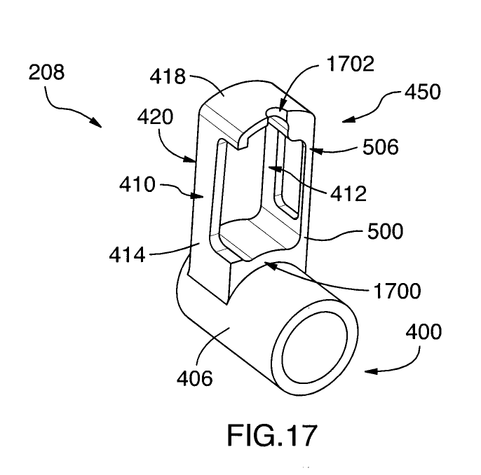

While in the illustrated embodiment, the bottom end 500 of the back wall 412 and the bottom end 414 of the front wall 410 are mounted to the shell wall 406 of the bottom bracket shell 400, the casing 450 may be configured differently. For instance, in an alternative embodiment shown in FIGS. 13A, 13B, 14, 15 and 17, the casing 450 may further comprises a base 1700 protruding from the shell wall 406, on which are mounted the bottom end 500 of the back wall 412 and the bottom end 414 of the front wall 410. In such an embodiment, the casing 450 and the bottom bracket shell 400 may be manufactured separately and the base 1700 of the casing 450 may then be welded to the shell wall 406 of the bottom bracket shell 400 using a welding technique known to the skilled addressee, thereby facilitating the manufacturing of the bottom bracket shell assembly 208.

Now referring back to FIGS. 2 to 10B, the top wall 418, front wall 410 and back wall 412 define a chamber 504 in the casing 450. The top wall 418, front wall 410 and back wall 412 further define a first side edge 420 located proximal to the first end 402 of the bottom bracket shell 400 and an opposed, second side edge 506. As best shown in FIG. 4, the first side edge 420 defines a rim 422 surrounding a generally rectangular access opening 424 for accessing the chamber 504 of the casing 450. The rim 422 is configured to enable securing a cover, not shown, to the first side edge 420 for preventing access to the chamber 504. More specifically, the rim 422 comprises a threaded hole 426 defined therein. The threaded hole 426 is configured for removably securing a corresponding cover fastener, not shown, as it will become apparent below.

It will be appreciated by the skilled addressee that the access opening 424 allows an operator to access cables passing through the chamber 504 for maintenance purposes. It will further be appreciated that the access opening 424 facilitates an installation of cables in the hollow frame 102 by allowing routing of cables through the chamber 504, for instance routing a cable running into the down tube 200 into a corresponding one of the left and the right chain stays 206, 204.

In the illustrated embodiment, the casing 450 extends between the first end 402 of the bottom bracket shell 400 and an intermediate region 600 located between the first end 402 and the second end 404 of the bottom bracket shell 400. The casing 450 is therefore off centered with reference to the first and second ends 402, 404 of the bottom bracket shell 400 and is located proximal to the first end 402 thereof. According to this configuration, the casing 450 further defines a seat tube receiving space 602 between the intermediate region 600 and the second end 404 of the bottom bracket shell 400. The seat tube receiving space 602 is adapted to allow positioning of the mounting portion 300 of the seat tube 202 adjacent to the casing 450, as will be further described below.

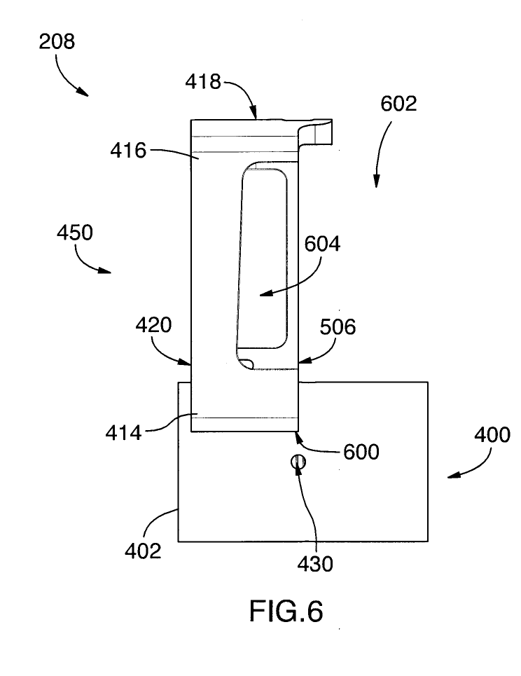

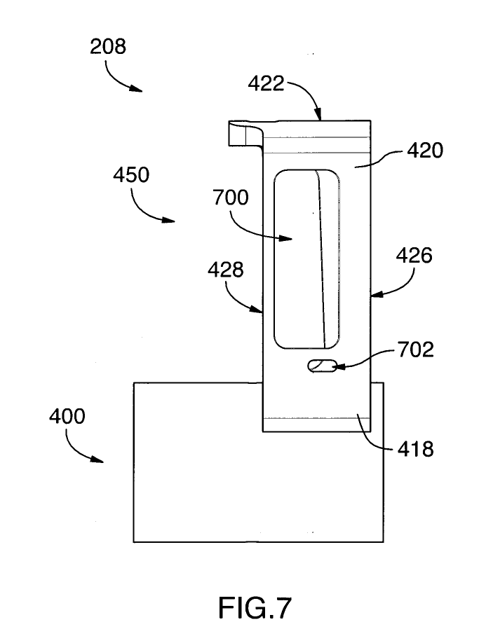

Referring to FIGS. 6 and 7, the casing 450 further comprises a plurality of openings sized and shaped for allowing the passage of at least one cable between the chamber 504 and the hollow frame 102. More specifically, the front wall 410 is generally planar and has a C-shaped wall configuration. Defined in the front wall 410 is a generally trapezoidal indentation 604 extending from the second side edge 506 of the casing 450 towards the first side edge 420 of the casing, best shown in FIG. 6. The indentation 604 defines a first communication opening allowing communication between the chamber 504 of the casing 450 and the down tube cavity, not shown, as it will become apparent below.

The back wall 412 is also planar and has a generally rectangular opening 700 defined therein, as best shown in FIG. 7. The generally rectangular opening 700 defines a second communication opening allowing communication between the chamber 504 of the casing 450 and the right chain stay 204, as it will become apparent below. Further defined in the back wall 412, below the rectangular opening 700, is a tie aperture 702 adapted for receiving a tying fastener such as a cable tie for fastening cables routed through the rectangular opening 700 to the back wall 412, as it will become apparent below.

Similarly to the first side edge 420, the second side edge 506 defines a rim 900 surrounding an oblong opening 902 located opposed the access opening 424 of the casing 450, as best shown in FIG. 9. The opening 902 defines a third communication opening allowing communication between the chamber 504 of the casing 450 and the interior of the seat tube 202 when the seat tube 202 is assembled with the bottom bracket shell assembly 208, as it will become apparent below.

In the embodiment illustrated in FIGS. 4 and 10, the top wall 418 is provided with a seat anti-theft mounting portion 428. More specifically, the seat anti-theft mounting portion 428 comprises a protrusion 1000, best shown in FIG. 10, extending sidewardly from the second side edge 506 of the casing 450. Defined in the protrusion 1000 is a hole 1002 configured for receiving therein a rod of a seat anti-theft assembly, not shown, operatively coupled to the seat assembly 110, as it will become apparent below. In the illustrated embodiment, the top wall 418 further has defined therein a generally square recess 1004 at the bottom of which is defined the hole 1002. The recess 1004 is sized and shaped to receive therein a corresponding lower portion of the rod, as it will also become apparent below.

In an alternative embodiment, shown in FIGS. 13A, 13B, 14, 15 and 17, the seat anti-theft mounting portion 428 comprises a semi-circular indent 1702 defined in the top wall 418 of the casing 450 and extending from the second side edge 506 of the casing 450 towards the first side edge 420 of the casing 450. The semi-circular indent 1702 is configured for receiving therein a rod of a seat anti-theft assembly, not shown, operatively coupled to the seat assembly 110, as it will become apparent below.

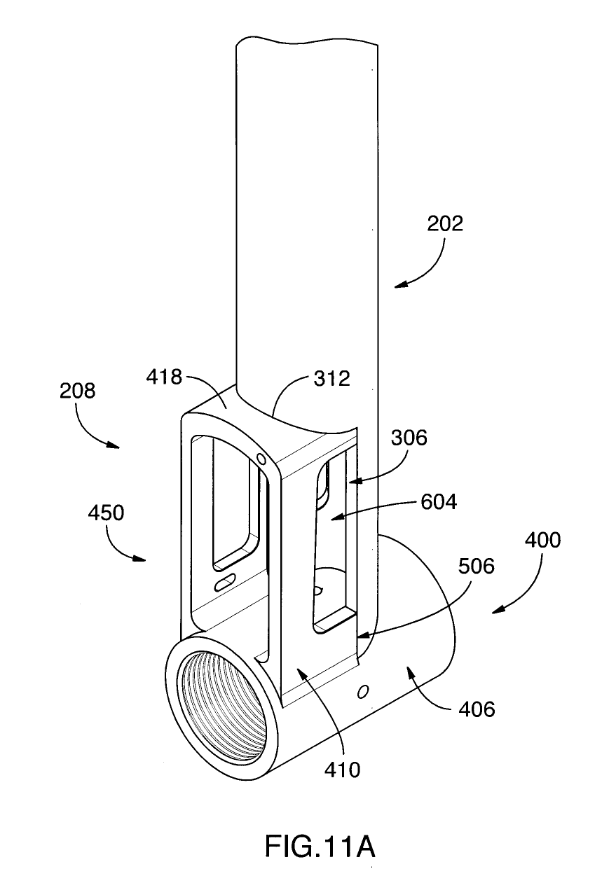

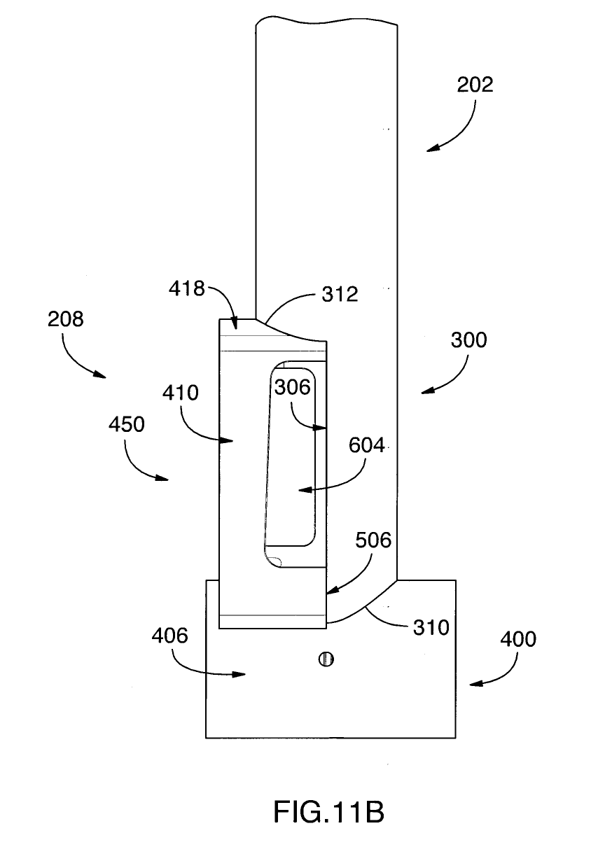

Now turning to FIGS. 11A and 11B, there is shown the seat tube 202 mounted to the bottom bracket shell assembly 208, in accordance with one embodiment.

In the illustrated embodiment, the mounting portion 300 of the seat tube 202 is sized and shaped for being received in the seat tube receiving space 602. The casing 450 and the mounting portion 300 of the seat tube 202 are complementary and are engaged such that the mounting portion 300 simultaneously contacts the casing 450 and the shell wall 406 of the bottom bracket shell 400.

More specifically, the mounting portion 300 is positioned adjacent to the second side edge 506 of the casing 450. The bottom edge 310 of the semi-cylindrical wall 304 of the mounting portion 300 is profiled to matingly contact the shell wall 406 while the upper edge 312 of the mounting portion 300 is profiled to matingly contact the top wall 418 of the casing 450. The first and second side edges 306, 308 of the semi-cylindrical wall 304 are adapted to matingly connect the second side edge 506 of the casing 450. The mounting portion 300 of the seat tube 202 therefore snuggly engages the bottom bracket shell assembly 208.

It will be noted that when the mounting portion 300 of the seat tube 202 snuggly engages the bottom bracket shell assembly 208, the first side edge 306 of the semi-cylindrical wall 304 becomes a vertical side edge of the indentation 604 of the front wall 410, thereby closing off the perimeter of the indentation 604, as best shown in FIG. 11B. Once the seat tube 202 is properly assembled with the bottom bracket shell assembly 208, the first side edge 306 of the semi-cylindrical wall 304 therefore prevents cables routed through the indentation 604 from escaping sidewardly from the indentation 604, as it will be appreciated by the skilled addressee.

In one embodiment, the mounting portion 300 of the seat tube 202 is welded to the bottom bracket shell assembly 208, thereby securing the seat tube 202 to the bottom bracket shell assembly 208. In such an embodiment, the first side edge 306 of the semi-cylindrical wall 304 is welded to the second side edge 506 of the casing 450, proximal to the front wall 410 thereof, by a front vertical joint and the second side edge 308 of the semi-cylindrical wall 304 is welded to the second side edge 506 of the casing 450, proximal to the back wall 412 thereof, by a back vertical joint. The skilled addressee will appreciate that, as welding joints are usually less resistant to shear efforts applied thereon, vertical welding joints, such as the front vertical joint joining the second side edge 506 of the casing 450 to the first side edge 306 of the semi-cylindrical wall 304 and the back vertical joint joining the second side edge 506 of the casing 450 and the second side edge 308 of the semi-cylindrical wall 304, advantageously provide enhanced robustness against efforts that may be applied sidewardly on the seat tube 202.

While in this embodiment, the bottom bracket shell assembly 208 has been described in connection with an off-centered casing 450, a person skilled in the art will appreciate that a number of different casing configurations are possible.

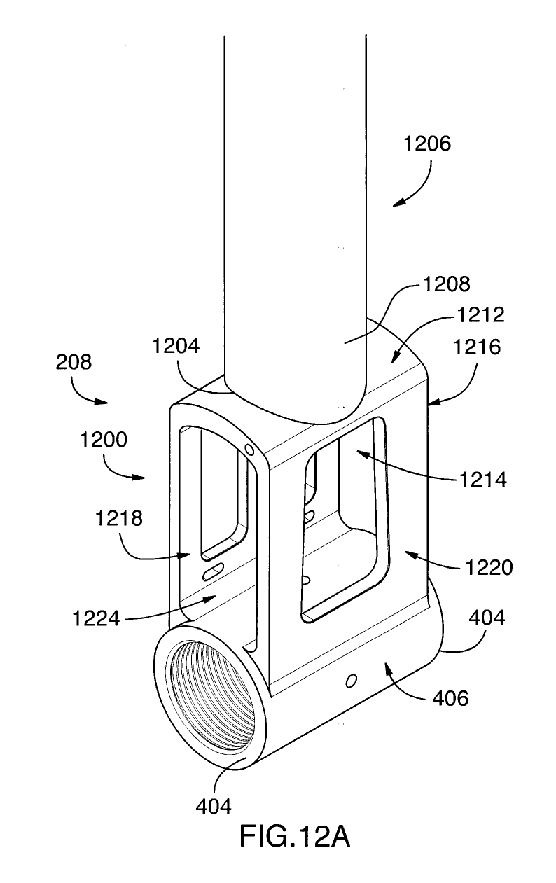

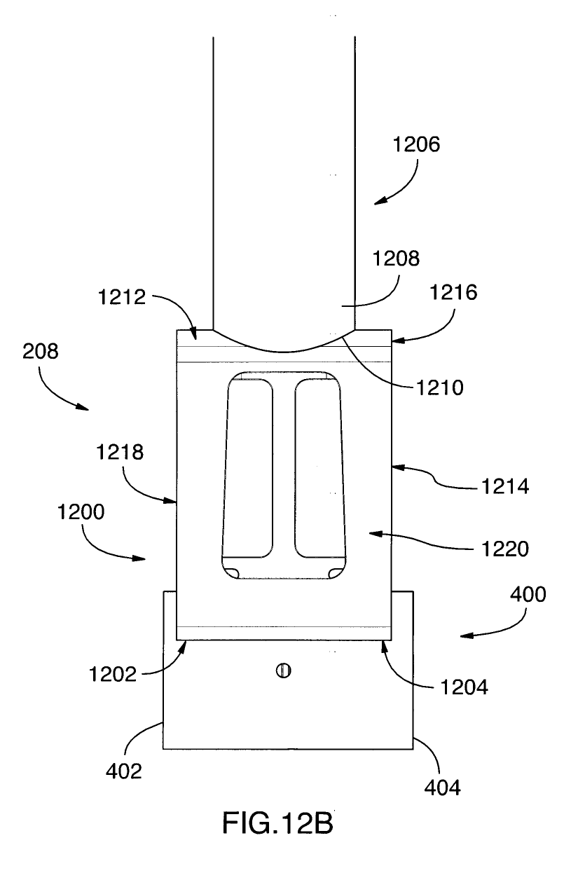

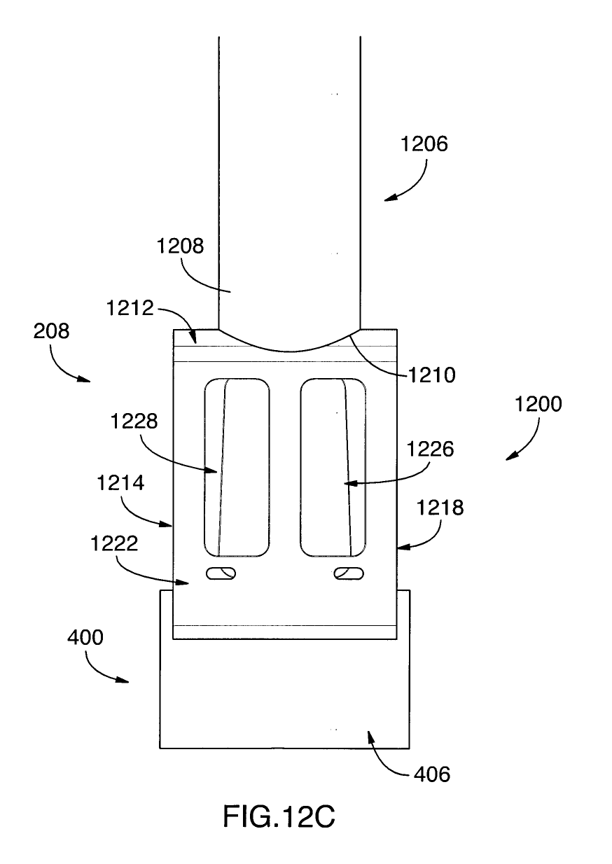

For instance, in an alternative embodiment shown in FIGS. 12A to 12C, a casing 1200 instead extends from a first location 1202 proximal to the first end 402 of the bottom bracket shell 400 to a second location 1204 located proximal to the second end 404 of the bottom bracket shell 400. Instead of having a mounting portion like the one extending at the bottom end 224 of the seat tube 202, there is provided a seat tube 1206 comprising a bottom end 1208 having a slightly curved, peripheral bottom edge 1210 adapted to matingly connect a top wall 1212 of the casing 1200.

Still in this alternative embodiment, the casing 1200 further comprises an end wall 1214 surrounded by a second side edge 1216 of the casing 1200, opposite an access opening 1218. The end wall 1206 extends between the top wall 1212, a front wall 1220, and a back wall 1222 of the casing 1200 and the shell wall 406 of the bottom bracket shell 400 to thereby prevent access to a chamber 1224 of the casing 1200 from the second location 1202.

In this alternative embodiment, the back wall 1222 comprises a first back opening 1226 and a second back opening 1228 disposed side-by-side. The first back opening 1226 and the second back opening 1228 are adapted for allowing passage of at least one cable therethrough, as it will become apparent below. In this embodiment, the right chain stay 204, not shown in FIGS. 12A to 12C, is connected to the back wall 1222 such that the first back opening 1226 allows communication between the right chain stay cavity, not shown, and the chamber 1224. Further, the left chain stay 206 is connected to the back wall 1222, beside the right chain stay 204, such that the second back opening 1228 allows communication between the left chain stay 306 and the chamber 1224.

In yet another embodiment, not shown, the bottom bracket shell assembly 208 may instead comprise a casing 450 having a single wall. For instance, such single wall may have a first end and a second opposed end, the first and second ends mounted to the shell wall 406 in a side-by-side relationship and a penannular wall extending therebetween. It will be appreciated that the casing 450 may have various designs according to aesthetic and/or structural considerations.

Having described the bottom bracket shell assembly 208, the seat assembly 110 will now be described with references to FIGS. 13A, 13B and 14. As it will become apparent, the seat assembly is coupled to a seat anti-theft assembly 1350 which collaborates with the bottom bracket shell assembly 208 to prevent unwanted removal of the seat assembly 110 from the seat tube 202 while enabling adjustment thereof to ensure the comfort of the user of the bicycle 100.

The seat assembly 110 comprises a seat post 1300 having a lower end 1302 slidingly engaged in the seat tube cavity 228 and an opposed upper end 1304 to which is securely mounted a seat 1306. The lower end 1302 of the seat post 1300 further comprises an inner circular flange, not shown, having therein defined a central hole, not shown, adapted to receive therein a rod 1308 of the seat-anti theft assembly 1350.

The rod 1308 of the seat anti-theft assembly 1350 is mounted in the seat tube cavity 228. The rod 1308 comprises an upper stopping end 1310 adapted for cooperating with the seat post 1304 to allow slidable movement of the seat post along a restricted path of movement and an opposed lower connecting end 1312 connected to the bottom bracket shell assembly 208. More specifically, the upper stopping end 1310 of the rod 1308 is configured to abuttingly engage the circular flange, not shown, of the seat post 1300 to prevent the lower end 1302 of the seat post 1300 from being slid upwardly such that the lower end 1302 of the seat post 1300 is disengaged from the rod 1308. The stopping end 1310 of the rod 1308 is therefore wider than the central hole, not shown, of the circular flange, not shown, of the seat post 1300.

The lower connecting end 1312 of the rod 1308 is adapted to be fastened to the top wall 418 of the casing 450, thereby securing the seat post 1304, and therefore the seat 1306, to the bicycle 100 while still allowing a user to adjust the height of the seat 1306 by sliding the seat post 1300 in the seat tube cavity 228.

More specifically, the rod 1308 of the seat anti-theft assembly 1350 comprises a central shaft 1314 and a narrower fastening portion 1316 extending axially from the connecting end 1312 of the rod 1308. The fastening portion 1316 is configured to engage the hole 1002 of the top wall 418 of the casing 450 and to partially extend in the chamber 504 of the casing 450, as best shown in FIG. 13B. The fastening portion 1316 is further provided with threads such that it may be secured to the top wall 418 of the casing 450 using a fastener 1318 such as a nut. The access opening 424 is advantageously shaped and sized to allow an operator to fasten the fastener 1318 on the narrow portion 1316 of the rod 1308 protruding in the chamber 504 using his hand or a tool such as a wrench.

Still in this embodiment, a shoulder 1320 is defined between the narrow portion 1316 of the rod 1308 and the central shaft 1314. In the illustrated embodiment, the shoulder 1320 has a noncircular cross-section and is shaped and sized to engage the corresponding recess 1004 of the top wall 418 of the casing 450. The skilled addressee will appreciate that the recess 1004, also being noncircular, prevents the rod 1308 from rotating when the fastener 1318 is being secured to the fastening portion 1316 of the rod 1308, thereby facilitating the installation of the seat anti-theft assembly 1350 on the bicycle 100.

In an alternative embodiment, the rod 1308 comprises an internally threaded cavity, not shown, extending axially and inwardly from the connecting end 1312 of the rod 1308. The connecting end 1312 of the rod 1308 has a noncircular cross-section and is shaped and sized to abuttingly engage the corresponding recess 1004 of the top wall 418 of the casing 450. It will be appreciated that the connecting end 1312 of the rod 1308 is wider than the hole 1002 of the top wall 418, thereby preventing the connecting end 1312 of the rod 1308 from passing through the hole 1002 of the top wall 418. When the connecting end 1312 of the rod 1308 is abuttingly engaged in the recess 1004, the cavity of the rod 1308 is aligned with the hole 1002 of the top wall 418 of the casing 450. The rod 1308 may then be fastened to the top wall 418 of the casing 450 using a male fastener such as a threaded bolt or the like.

Now referring to FIG. 14, the drive assembly 112 of the bicycle 100 is depicted in accordance with one embodiment.

The drive assembly 112 comprises the bottom bracket 1400 adapted for rotatably engaging the bottom bracket shell 400. The bottom bracket 1400 is generally cylindrical and comprises a first end 1402 having a first crank arm 1404 mounted thereto and an opposed second end, not shown, having a second crank arm 1406 mounted thereto. The first and second crank arms 1404, 1406 are respectively provided with a first and second pedal 1408, 1410 adapted to allow a user riding the bicycle 100 to rotate the bottom bracket 1400 using his feet. Mounted to the first end 1402 of the bottom bracket is a sprocket 1412 operatively coupled to the rear wheel 106 by a chain 1414 extending therebetween for transmitting power to the rear wheel 106 when the bottom bracket 1400 is rotated. The drive assembly 112 further comprises a chain guide 1415 for guiding the chain 1414 along a desired path and a chain cover 1416 mounted over the chain 1414 to partly conceal the chain 1414.

In the illustrated embodiment, the cover of the access opening 424 comprises a plate 1418 of the drive assembly 112. The plate 1418 is removably mounted to the frame 102, between the sprocket 1412 and the bottom bracket shell assembly 208, when the drive assembly 112 is installed on the bicycle 100. The cover fastener 1420 engages the corresponding threaded hole 426 of the rim 422 surrounding the access opening 424 and maintains the plate 1418 in abutment against the rim 422, thereby preventing access to the chamber 504.

It will be appreciated that in this configuration, the chamber 504 of the casing 450 may not be accessed unless the plate 1418 is removed. In one embodiment, the cover fastener 1420 is adapted to be removed using a dedicated tool. For instance, the cover fastener 1420 may comprise a security screw and the dedicated tool may comprise a corresponding security bit mounted to a screwdriver. This is of great advantage, especially when the bicycle 100 is used in a bicycle sharing program and the dedicated tool is in the possession of an operator of the bicycle sharing program. This provides to the operator of the bicycle sharing program exclusive access to the chamber 504, thereby preventing a malevolent person from accessing the chamber 504 and vandalizing cables passed through the hollow frame. This configuration further provides easy access to the chamber 504 to enable the operator to perform maintenance therein.

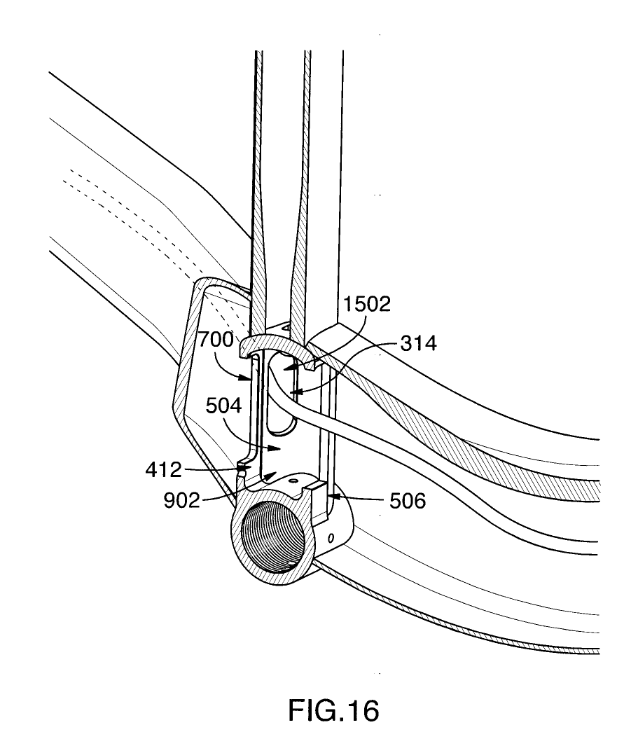

Having described the components of the bottom bracket shell assembly 208 and the hollow frame 102, an example of routing of cables through the hollow frame 102 will now be described, with references to FIGS. 1, 2, 15 and 16.

A handlebar 150 is mounted to the fork assembly 104 and allows a user to steer the bicycle 100. The handlebar 150 comprises a first handle 152 and a second opposed handle 154 each adapted to be gripped by a hand of a user. The handlebar 150 further comprises a plurality of control levers mounted thereto. In this embodiment, the handlebar 150 and the fork assembly 104 are hollow and in communication with each other. This configuration allows cables to be routed from the control levers through the handlebar 150 and the fork assembly 104 towards controls located away from the handlebar 150 such as back and front brakes and a gear shifting unit, as it will become apparent below.

In one embodiment, the bicycle 100 comprises a front brake assembly. The front brake assembly 100 comprises a front brake 160 mounted to the fork assembly, near a hub 162 of the front wheel 108, and a front brake lever 164 mounted to the handle bar 150, proximal to one of the first and, second handles 152, 154 of the handlebar 150 for activating the front brake 160. The front brake lever 164 and the front brake 160 are operatively connected together by a front brake cable, not shown, having a lever end connected to the front brake lever 164 and a brake end connected to the front brake 160.

For installing the front brake assembly to the bicycle 100, the front brake lever 164 is first securely mounted to the handlebar 150 and the front brake 160 is securely mounted to the fork assembly 104. The lever end of the front brake cable, not shown, is then connected to the front brake lever 164. The brake end of the front brake cable, not shown, is then routed downwardly through the hollow handlebar 150 and through the hollow fork assembly 104 towards the front brake 160. The brake end of the brake cable, not shown, then exits the hollow fork assembly 104 by an opening defined therein, near the front brake 160, and is connected to the front brake 160.

In the illustrated embodiment, the bicycle 100 further comprises a rear brake assembly. The rear brake assembly comprises a rear brake 170 mounted to the left chain stay 204, near a hub 172 of the back wheel 106 and a rear brake handle 174 mounted to one of the first and second handles 152, 154 of the handlebar 150 for activating the rear brake 170. The rear brake lever 174 and the rear brake 170 are operatively connected together by a rear brake cable 1500 having a lever end, not shown, connected to the rear brake lever 174 and a brake end, not shown, connected to the rear brake 170.

For installing the rear brake assembly to the bicycle 100 according to one embodiment, the rear brake lever 174 is first securely mounted to the handlebar 150 and the rear brake 170 is securely mounted to the left chain stay 304. The lever end of the rear brake cable 1500 is then connected to the rear brake lever 174. The brake end, not shown, of the rear brake cable 1500 is then routed through the handlebar 150, through the fork assembly 104 and into the down tube cavity 1502 by a front opening 270 defined in the head tube 220. The brake end of the rear brake cable 1500 is then routed through the down tube cavity 1502 towards the casing 450 and enters the chamber 504 of the casing through the indentation 604 of the casing 450.

The rear brake cable 1500 is then routed through the chamber 504 towards the left chain stay cavity 1504. The access opening 424 of the casing advantageously allows an operator to do so. In one embodiment, the access opening 424 is sized and shaped to allow routing of cables therein using an elongated tool such as a pair of pliers or a dedicated cable routing tool. In an alternative embodiment, the access opening 424 is sized and shaped to allow an operator to route cables in the chamber 504 using his hands.

The brake end of the rear brake cable 1500 is then routed through the opening 902 of the second side edge 506 of the casing 450 into the interior of the seat tube 202 and further through the lower opening 314 of the seat tube 202, into the left chain stay cavity 1504.

The brake end of the rear brake cable 1500 is then routed through the left chain stay cavity 1504, exits through an opening, not shown, defined therein, near the rear brake 170, and is connected o the rear brake 170.

For installing the rear brake assembly according to an alternative embodiment, the rear brake lever 174 is first securely mounted to the handlebar 150 and the rear brake 170 is securely mounted to the left chain stay 206. In this embodiment, the rear brake cable 1500 is introduced through the access opening 424 of the casing 450. More specifically, the brake end of the rear brake cable 1500 is introduced in the chamber 504 of the casing 450 through the access opening 424 and routed through the third communication opening 902 in the interior of the seat tube 202 and through the lower opening 314 of the seat tube 202 into the left chain stay cavity 1504. The brake end of the rear brake cable 1500 is then routed through the left chain stay cavity 1504, exits through an opening, not shown, defined therein, near the rear brake 170, and is connected to the rear brake 170.

The lever end, not shown, of the rear brake cable 1500 is introduced in the chamber 504 of the casing 450 through the access opening 424, is routed through the indentation 604 into the down tube cavity 1502 and through the down tube cavity 1502 towards the front opening 270 of the head tube 220. The lever end, not shown, of the rear brake cable 1500 is further routed through the handlebar 150 and through the fork assembly 104 to be connected to the rear break lever 174.

According to one embodiment, the bicycle 100 may further comprise a gear assembly. More specifically, the gear assembly comprises a gear shifter 180 mounted to the handlebar 150, proximal to one of the first and second handles 152, 154, and a gear shifting unit 182 mounted to the right chain stay 204, near the hub 172 of the rear wheel 106. The gear shifter 180 and the gear shifting unit 182 are connected together using a gear cable 1510 having a shifter end, not shown, connected to the gear shifter 180 and a unit end, not shown, connected to the gear shifting unit 182. It will be appreciated that the gear cable 1510 is installed similarly to the rear brake cable 1500, except that the unit end of the gear cable 1510, once in the chamber 504 of the casing 450, is routed into the right chain stay cavity 1506 through the opening 700 of the back wall 412 of the casing 450. The unit end of the gear cable 1510 is then routed through the right chain stay cavity 1506, exits through an opening defined in the right chain stay 204, near the gear shifting unit 182, and is connected to the gear shifting unit 182.

In an alternative embodiment, the seat tube cavity 228 may be adapted for passing cables or wires therethrough. For instance, where the rear brake comprises a rim brake mounted to the left or right seat stay 212, 210 near the top open end 222 thereof rather than on the left or right chain stay 206, 204, the rear brake cable 1500 may be passed through the down tube 200, the bottom bracket shell assembly 208 and the seat tube 202, from the bottom end 224 thereof to an exit opening located near the top open end 222 thereof, if the manufacturer wants such rear brake cable to be concealed within the frame 102. This configuration advantageously allows a great portion of the rear brake cable to remain concealed in the hollow bicycle frame 102.

In one embodiment, the bicycle 100 may further comprise left and right rear lights, not shown, for instance mounted to the left and right chain stays 206, 204. The left and right rear lights are operatively connected to a power source. In this embodiment, the left and right rear lights may be operatively connected to a dynamo, not shown, mounted to the front wheel 108 by left and right wires, not shown. The skilled addressee will appreciate that the left and right wires are routed to their respective left and right rear lights in the same manner as described above with the gear cable 1510 and the rear brake cable 1500 as examples.

In an alternative embodiment, the left and right rear lights may be connected to a battery. In this embodiment, the battery is sized and shaped to fit within the chamber 504 of the casing 450. The left wire is routed from the chamber 504 of the casing 450 towards the left chain stay cavity 1504 through the lower opening 314 defined in the semi-cylindrical wall 304 of the seat tube 202. The right wire is routed from the chamber 504 of the casing 450 towards the right chain stay cavity 1506 through the opening 700 of the back wall 412 of the casing 450. The access opening 424 of the casing 450 advantageously allows an operator to perform maintenance on the battery of to replace a depleted battery by an energized battery.

In another embodiment, the bicycle 100 comprises a central rear light, not shown, mounted to the seat tube 202, near the top end 222 thereof, the rear light being connected to a dynamo mounted to the front wheel 108 by a rear light wire. In such an embodiment, the rear light wire is passed through the hollow down tube 200, through the bottom bracket shell assembly 208 and through the hollow seat tube 202 from the bottom end 224 thereof to an exit opening located near the top end 222 thereof. This configuration advantageously allows a great portion of the rear light wire to remain concealed in the hollow bicycle frame 102.

In one embodiment, as best shown in FIG. 1, the chain is passed through the right chain stay cavity 1506. More specifically, the right chain stay 304 encloses a substantial portion of the chain for protecting a user from contacting the chain when the chain is moving and hurting himself or damaging a piece of clothing. However, the skilled addressee will appreciate that, if the moving chain contacts wires or cables passing in the right chain stay cavity 1506, it may damage the wires or cables. Accordingly, in such an embodiment, a cable tie adapted to maintain cables away from the chain may be provided. For instance, as best shown in FIG. 7, the tie aperture 702 defined in the back face 412 of the casing 450 is adapted to be engaged by the cable tie adapted to secure the gear cable 1510 and the right rear light wire to a lower portion of the right chain stay cavity 1506, therefore keeping them away from the chain to prevent them from getting damaged.

Although the above description relates to a specific preferred embodiment as presently contemplated by the inventor, it will be understood that the invention in its broad aspect includes mechanical and functional equivalents of the elements described herein.

1. A bottom bracket shell assembly for use with a hollow frame of a pedal powered vehicle, the assembly comprising:
a bottom bracket shell comprising a first side open end, a second, opposed side open end and a shell wall extending therebetween, the shell wall defining a cylindrical cavity adapted for receiving a bottom bracket therein;
a casing mounted to the shell wall of the bottom bracket shell and extending upwardly therefrom, the casing comprising at least one wall defining a chamber and a closable access opening for accessing the chamber, the at least one wall comprising at least one communication opening adapted to allow communication between the interior of the hollow frame and the chamber.

2. The assembly as claimed in claim 1, wherein the casing comprises a back wall having a bottom end connected to the shell wall and a top end, a spaced-apart front wall having a bottom end connected to the shell wall and a top end, and a top wall connecting the top end of the back wall to the top end of the front wall.

3. The assembly as claimed in claim 2, wherein the back, front and top walls define together a first side edge and a second side edge.

4. The assembly as claimed in claim 3, wherein the first side edge defines a rim surrounding the access opening, the rim being configured to enable securing a cover to the first side edge for preventing access to the chamber.

5. The assembly as claimed in claim 4, wherein the rim comprises at least one threaded hole defined therein, the at least one threaded hole being configured for removably securing at least one corresponding cover fastener therein, wherein when the at least one cover fastener is secured in the at least on threaded hole, the cover is maintained in abutment against the rim thereby preventing access to the chamber.

6. The assembly as claimed in claim 5, wherein the at least one cover fastener is adapted to be removed using a dedicated tool.

7. The assembly as claimed in claim 2, wherein the at least one communication opening comprises a hole extending through one of the back wall, the front wall and the top wall.

8. The assembly as claimed in claim 3, wherein the at least one communication opening comprises an indentation defined in the second side edge.

9. The assembly as claimed in claim 8, wherein the indentation is defined in the front wall.

10. The assembly as claimed in claim 3, wherein the at least one communication opening is surrounded by the second side edge of the casing.

11. The assembly as claimed in claim 3, wherein the casing is configured for enabling a portion of a seat tube of the frame to simultaneously contact the casing and the shell wall.

12. The assembly as claimed in claim 11, wherein the casing extends between the first end of the shell wall to an intermediate region located between the first and second ends thereof to allow positioning of a portion of the seat tube adjacent to the casing.

13. The assembly as claimed in claim 12, wherein the casing comprises three communication openings.

14. The assembly as claimed in claim 13, wherein the three communication openings comprise a first communication opening defined in the front wall, a second communication opening defined in the back wall and a third communication opening surrounded by the second side edge.

15. The assembly as claimed in claim 11, wherein the top wall comprises a saddle anti-theft mounting portion.

16. The assembly as claimed in claim 15, wherein the saddle anti-theft mounting portion comprises a protrusion extending sidewardly from the second side edge and a hole extending through the protrusion, the hole being configured for abuttingly receiving therein a rod.

17. The assembly as claimed in claim 16, wherein the hole extends in a recess defined on the top wall, the recess being sized and shaped to receive therein a corresponding portion of the rod when the rod is received in the hole.

18. The assembly as claimed in claim 17, further comprising a fastener for securely fastening the rod to the top wall once the rod has been engaged in the hole.

19. The assembly as claimed in claim 3, further comprising a cover fixedly mounted to the second side edge to prevent access to the chamber.

20. The assembly as claimed in claim 19, wherein the casing comprises three communication openings.

21. The assembly as claimed in claim 20, wherein the three communication openings comprise a first communication opening defined in the front wall and second and third communication openings defined in the back wall.

22. The assembly as claimed in claim 1, wherein the pedal powered vehicle comprises a pedal powered vehicle for a sharing system.

23. The assembly as claimed in claim 1, wherein the pedal powered vehicle is selected from a group consisting of a bicycle and a tricycle.

24. A hollow frame for a pedal powered vehicle, the hollow frame comprising:
a hollow down tube having a first, upper end for connecting a fork assembly to the frame and a second, lower end;
a hollow seat tube having a first, upper open end for mounting a saddle assembly to the seat tube and a second lower end;
at least one hollow chain stay having a first, rear end for mounting a rear wheel to the frame and a second, front end;
a bottom bracket shell assembly connected to the lower end of the seat tube, the lower end of down tube and the front end of the at least one chain stay, the bottom bracket shell assembly comprising:
a bottom bracket shell comprising a first side open end, a second, opposed side open end and a shell wall extending therebetween, the shell wall defining a cylindrical cavity adapted for receiving a bottom bracket therein; and
a casing mounted to the shell wall of the bottom bracket shell and extending upwardly therefrom, the casing comprising at least one wall defining a chamber and a closable access opening for accessing the chamber, the at least one wall comprising at least one communication opening adapted to allow communication between the chamber and the interior of at least one of the down tube, the seat tube and the chain stay.

25. The frame as claimed in claim 24, wherein the casing comprises:
a front wall adjacent to the second, lower end of the down tube, the front wall having a bottom end connected to the shell wall and a top end;
a spaced-apart back wall adjacent to the second, front end of the chain stay, the back wall having a bottom end connected to the shell wall and a top end; and
a top wall connecting the top end of the back wall to the top end of the front wall.

26. The frame as claimed in claim 25, wherein the back, front and top walls define together a first side edge and a second side edge.

27. The frame as claimed in claim 26, wherein the first side edge defines a rim surrounding the access opening, the rim being configured to enable securing a cover to the first side edge for preventing access to the chamber.

28. The frame as claimed in claim 27, wherein the rim comprises at least one threaded hole defined therein, the at least one threaded hole being configured for removably securing at least one corresponding cover fastener therein, wherein when the at least one cover fastener is secured in the at least on threaded hole, the cover is maintained in abutment against the rim thereby preventing access to the chamber.

29. The frame as claimed in claim 28, wherein the at least one cover fastener is adapted to be removed using a dedicated tool.

30. The frame as claimed in claim 25, wherein the at least one communication opening comprises a hole extending through one of the back wall, the front wall and the top wall.

31. The frame as claimed in claim 26, wherein the at least one communication opening comprises an indentation defined in the second side edge.

32. The frame as claimed in claim 31, wherein the indentation is defined in the front wall.

33. The frame as claimed in claim 26, wherein the at least one communication opening is surrounded by the second side edge of the casing.

34. The frame as claimed in claim 26, wherein the casing of the bottom bracket shell assembly and the seat tube are configured for enabling a portion of the seat tube to simultaneously contact the casing and the shell wall of the bottom bracket shell assembly.

35. The frame as claimed in claim 34, wherein:
the casing of the bottom bracket shell assembly extends between the first end of the shell wall to an intermediate region located between the first and second ends thereof thereby defining a seat tube receiving space between the intermediate region and the second end of the shell wall; and
the seat tube comprises a mounting portion extending at the second, lower end thereof, the seat tube mounting portion being sized and shape for being received in the seat tube receiving space and simultaneously mating connection with shell wall and the casing of the bracket shell assembly.

36. The frame as claimed in claim 35, wherein the casing comprises three communication openings.

37. The frame as claimed in claim 36, wherein the three communication openings comprise a first communication opening defined in the front wall, the first communication opening allowing communication between the chamber of the casing and the interior of the down tube.

38. The frame as claimed in claim 37, wherein the three communication openings further comprise a second communication opening defined in the back wall, the second communication opening allowing communication between the chamber of the casing and the at least one chain stay.

39. The frame as claimed in claim 38, wherein the three communication openings further comprise a third communication opening defined by the second side edge, the third communication opening allowing communication between the chamber and the interior of the seat tube.

40. The frame as claimed in claim 39, wherein the frame comprises two chain stays and the seat tube comprises a lower opening, the back wall of the casing being adjacent to a first chain stay and the seat tube mounting portion being adjacent to a second chain stay, the second communication opening allowing communication between the chamber of the casing and the first chain stay and the lower opening allowing communication between the interior of the seat tube and the second chain stay.

41. The frame as claimed in claim 35, wherein the top wall comprises a saddle anti-theft mounting portion.

42. The frame as claimed in claim 41, wherein the saddle anti-theft mounting portion comprises a protrusion extending sidewardly from the second side edge and a hole extending through the protrusion, the hole being configured for abuttingly receiving therein a rod.

43. The frame as claimed in claim 42, wherein the hole extends in a recess defined on the top wall, the recess being sized and shaped to receive therein a corresponding portion of the rod when the rod is received in the hole.

44. The frame as claimed in claim 44 further comprising a fastener for securely fastening the rod to the top wall once the rod has been engaged in the hole.

45. The frame as claimed in claim 26, further comprising a cover fixedly mounted to the second side edge to prevent access to the chamber.

46. The frame as claimed in claim 45, wherein the casing comprises three communication openings.

47. The frame as claimed in claim 46, wherein the three communication openings comprise a first communication opening defined in the front wall, the first communication opening allowing communication between the chamber of the casing and the interior of the down tube.

48. The frame as claimed in claim 47, wherein the three communication openings further comprise a second communication opening defined in the back wall, the second communication opening allowing communication between the chamber of the casing and a first chain stay.

49. The frame as claimed in claim 48, wherein the three communication openings further comprise a third communication opening defined in the back wall, the third communication opening allowing communication between the chamber of the casing and a second chain stay.

50. The frame as claimed in claim 24, wherein the pedal powered vehicle comprises a pedal powered vehicle for a sharing system.

51. The frame as claimed in claim 24, wherein the pedal powered vehicle is selected from a group consisting of a bicycle and a tricycle.
